(19) United States
(12) Patent Application Publication
(10) Pub. No.: US 2017/0193216 A1
(43) Pub. Date: Jul. 6, 2017

(54) PASSWORD GENERATION SYSTEM AND PROCESS

(71) Applicant: James B. Lucas, Fort Myers, FL (US)

(72) Inventor: James B. Lucas, Fort Myers, FL (US)

(21) Appl. No.: 15/467,257

(22) Filed: Mar. 23, 2017

Related U.S. Application Data
(63) Continuation-in-part of application No. 14/454,994, filed on Aug. 8, 2014, now Pat. No. 9,647,839.

(51) Int. Cl. G06F 21/45; H04L 9/32; H04L 29/06

(52) U.S. Cl. CPC G06F 21/45; H04L 63/083; H04L 9/3226

(57) ABSTRACT

The present invention seeks to meet these needs by providing a password generation system and process that generates encrypted passwords with a computer program using an algorithm that combines a website information such as a domain name or email address, the user's own text input or phrase, and the user's own numeric value or pin number. The present invention does not involve the maintenance of a database of any kind. As such, there is no login required and no records are kept of the visitors, their input or the passwords generated. Preferably, the process is carried out using a website, browser extension, smart phone application and/or a stand-alone executable program.

### CROSS-REFERENCE TO RELATED APPLICATIONS

This application is a continuation-in-part of application Ser. No. 14/454,994 filed on Aug. 8, 2014 which claims priority to U.S. Provisional Application No. 61/864,549 filed Aug. 10, 2013. The entire contents of the above applications are hereby incorporated by reference as though fully set forth herein.

### FIELD OF THE INVENTION

The present invention generally relates to online security and more particular to providing regeneratable secure passwords for use on a third party website using an embedded secure system module which is non-communicative with the third party website, thereby preventing a need for login and/or password information from being stored on the third party website and/or web browser on which the third party website is being accessed and viewed.

### BACKGROUND OF THE INVENTION

Almost all modern computer networks and web applications have a user password to access encrypted personal and sensitive data. Many times, the password themselves are encrypted. The reason for encryption of passwords is that the password itself is sensitive personal data. Passwords are the key to a user's privacy, so they are personal, sensitive and not even the web application or network host should know them. If the password to a web application or database is compromised, then all the data contained therein is compromised as well. There are many methods used to create and store complex passwords for users, but even those methods are not infallible if the password is not strong enough, as a brute force attack (iteratively trying every possible value) or a dictionary attack (trying a subset of preferred values) can still reveal the password. Some of these tools to carry out these attacks are even available on the Internet, for example the John the Ripper password cracker.

Users with weak passwords are often victims of hackers and spammers who exploit security holes in computer systems. For example, a hacker can crack a weak password on an email account and the hacker uses the account to circulate spam or even commit identify theft. A weak password also opens computer networks to worms, trojans, spyware and other forms of malware used to infect the computers of people visiting the site. As such, it is generally recommended that a strong password is at least six to eight characters in length and should contain a mixture of numbers, letters (both uppercase and lowercase), and symbols. However, these passwords are often difficult to remember. Putting the password on a sticky note next to the computer monitor represents a security risk as does keeping a Word document, notepad file, or excel spreadsheet that contains all sites and passwords. Often times, users will use the same password for multiple sites. If one site is breached, such as email, then often another site can be breached, such as one used for banking.

It is possible to encrypt a “master” document containing these strong passwords, but if that master file is lost, corrupted, deleted, stolen, destroyed, breached or the user forgets the master password, the data can be forever lost. While there are password repository websites and Internet browsers that save passwords, these can also be breached and their databases revealed or hacked and shared. Further, these sites require a user to create a login credentials to an account that saves their passwords in a database for future retrieval, thereby keeping records of the user, their input and the passwords generated.

Therefore, a need exists for an invention that provides regeneratable secure passwords for use on a third party website using an embedded secure system module which is non-communicative with the third party website, thereby preventing a need for login and/or password information from being stored on the third party website and/or web browser on which the third party website is being accessed and viewed.

### SUMMARY OF THE INVENTION

The present invention seeks to meet these needs by providing a password generation system that generates encrypted passwords with a computer program using an algorithm that combines a website information such as a domain name or email address, the user's own text input or phrase, and the user's own numeric value or pin number. The present invention does not involve the maintenance of a database of any kind. As such, there is no login required and no records are kept of the visitors, their input or the passwords generated. Preferably, the process is carried out using a website, browser extension, smart phone application and/or a stand-alone executable program.

The present invention is preferably a system module that is accessible from a third party website. The system module is accessible through an SSL popup window on which a password is generated by entering at least two random values, such as user's own text input or phrase, and the user's own numeric value or pin number, which are made up by the user. An encrypted password is then generated using the at least one random value. The encrypted password may then be entered into the password field of the third party website.

The password may be regenerated at any time through the system module. Therefore, the need and/or desire by the user to save the password on the login page or in the web browser is greatly reduced.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flowchart example of the password generation system and process, utilized to implement an illustrative embodiment of the present invention; and

FIG. 2 is a flow chart showing the components of the system and process of the present invention wherein a system module is provided through a module link on a third party website for a user to generate and/or regenerate an encrypted password to be used for accessing the third party website

### DESCRIPTION OF THE PREFERRED EMBODIMENTS

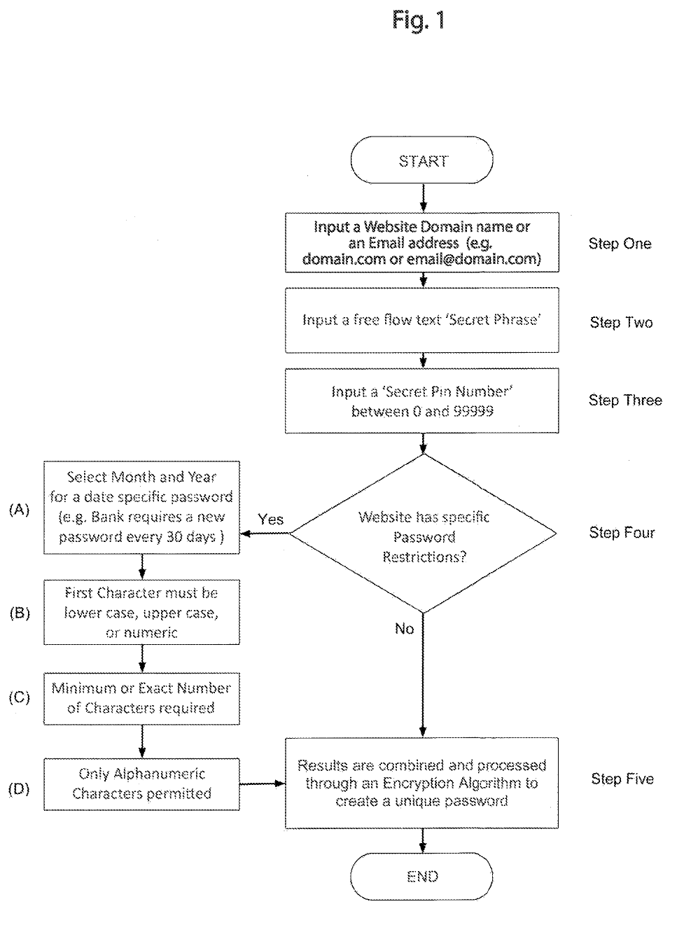

The password generation system and process is illustrated as a sequence of processes as shown in FIG. 1. In Step One, the user inputs the domain name, URL of the website or email address for which they want to create a strong encrypted password. In Step Two, the user inputs a free flow text of their own easy to remember secret phrase. In Step Three, the user inputs a secret number between 1 and 99999. In Step Four, the system can be customized to include additional input requirements for the password creation. For example, many websites require passwords to contain a certain number of characters, a combination of upper and lowercase letters, or even symbols. As shown in FIG. 1, in Step Four (A) thru (D), the user is prompted to enter additional options that can be customized to meet website password requirements. As shown in “A”, the user may select a month and year for a date specific password, as in some cases a website, such as a bank, may require a new password every 30 days. As shown in “B”, the user must select the first character in the password as a lower case, upper case or numeric character. As shown in “C”, the minimum or exact number of characters can be specified. As shown in “D”, a limitation of only alphanumeric characters in the password can be implemented (i.e., no symbols such as #, %, *) The number of options and/or limitations provided in Step Four are not limited to those state herein, as they could be customized to each specific website requirements. In Step Five, the results are combined and processed through an encryption algorithm to create a unique password.

A further embodiment of the present invention is to provide hash tags within a link such that webmasters can specify which options or limitations to the password generation the website accommodates. For example, a website may offer their users a “Visit WordCrypt to create your Password” link as https://wordcrypt.com/#lower-char25-alphanum which would specify first character lower case, 25 characters, and no special characters.

One key novel aspect of the present invention is that even though the user has not created a login account that keeps record of the user, every time the user inputs the same domain name, secret phrase and secret number, the same password is created. The user is able to maintain anonymity and the password generation system compiles and encrypts the user data into a unique password just for that domain name, user phrase and number. As such, the user is able to save a difficult password for each website using easy to remember information to retrieve the password, thereby eliminating the need for sticky notes, Word docs, spreadsheets, notepad files and 3rd party database depositories.

In the preferred embodiment, the password encryption system is practiced using a website to compile the input details and provide the encrypted password. However, the present invention may also be practiced in other formats such as browser extension (Chrome, Firefox, Internet Explorer, Opera, and Safari), smart phone applications (Android, iPhone, Blackberry and Windows phones), and/or stand alone executable programs (Windows, Mac, and Linux).

In the preferred embodiment, the algorithm used to encrypt the password is an irreversible cryptographic hash function that generates passwords and then transmits them through the Secure Socket Layer protocol, which creates an encrypted connection between the user's computer and the website server. However, it is understood that many different types of encryption methods, those known and unknown, can function with the PGRS of the present invention.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

By providing a password generation system that generates encrypted passwords with a computer program using an algorithm that combines a website information such as a domain name or email address, the user's own text input or phrase, and the user's own numeric value or pin number. The present invention does not involve the maintenance of a database of any kind. As such, there is no login required and no records are kept of the visitors, their input or the passwords generated. Preferably, the process is carried out using a website, browser extension, smart phone application and/or a stand-alone executable program.

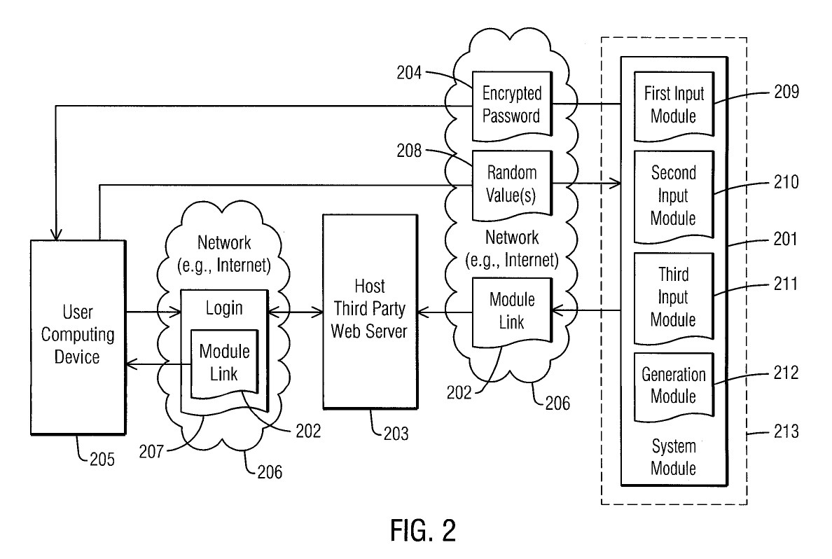

With reference to FIG. 2, a flow chart showing the components of the system and process of the present invention wherein a system module 201 is provided through a module link 202 on a third party website 203 for a user to generate and/or regenerate an encrypted password 204 to be used for accessing the third party website 203 is illustrated. The system and process of the present invention is preferably presented to a user through a system module 201 that is reachable by the user through an embedded module link 202 on a third party website 203. The system module link 202 may be accessible through a plugin or SSL popup window through which the user can communicate via the user's computing device 205 directly with the password generator system module 201.

For example, the user accesses a third party website or webserver 203 over a network 206. The user is presented with a login page 207 for the third party website 203 which is a host third party website 203 providing access to the system module 201 via a module link 202. The user may then access the password generator system module 201 hosted on a separate web server via the embedded module link 202. The user may then generate and/or regenerate a previously generated password by providing at least one random value 208, such as user's own text input or phrase, and the user's own numeric value or pin number, which are made up by the user. An encrypted password 204 is then generated using the one or more random values 208 and provided to the user. The password 204 is provided directly to the user bypassing the third party webserver 203. The encrypted password 204 may then be entered into the login page 207.

The system module 201 comprises at least one input module for entry of a random value 208, such as user's own text input or phrase, the user's made up numeric value or pin number, website data, and so forth. As illustrated here, a first input module 209, a second input module 210 and a third input module 211 are provided. For example, a user may enter website data into the first input module 209, a made up phrase into the second input module 210 and a numeric value into the third input module 211. Website data may also be automatically entered. Then a generation module 212, through the use of a system computer device 213, combines and processes the entered random values 208 through an encryption algorithm to create a unique password 204 which is provided directly to the user bypassing the third party webserver 203 so that the password 204 may be manually entered into the login 207 of the host third party website 203.

The unique password 204 may then be subsequently recalled by entering the same random values 208 into the input modules 209, 210, 211. Therefore, the need and/or desire by the user to save the password 204 on the login page 207 or in a web browser in which the login page 207 is being viewed is greatly reduced.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A password generation system comprising:
a computer executing a computer program to combine and process website data and unique user identification data through an encryption algorithm;
a first input interface module for entry of the website data;
a second input interface module for the user to enter the unique user identification data;
the program combines and processes the website data, the unique user identification data and the password restriction customized to meet a website requirement through the encryption algorithm to create a unique password; and
a recall interface module executed by the computer to use input of the original website data and the unique user identification data to recreate the unique password from the computer.

2. A password generation system comprising:
a computer executing a computer program to combine and process website data and unique user identification data through an encryption algorithm;
a first input interface module for entry of the website data;
a second input interface module for the user to enter the unique user identification data;
a third input interface module for including a password restriction customized to meet a website requirement;
the program combines and processes the website data, the unique user identification data and the password restriction customized to meet a website requirement through the encryption algorithm to create a unique password; and
a recall interface module executed by the computer to use input of the original website data and the unique user identification data to recreate the unique password from the computer.

3. A password generation system comprising:
a computer executing a computer program to combine and process website data and unique user identification data through an encryption algorithm;
a first input interface module for entry of the website data;
a second input interface module for the user to enter the unique user identification data;
a third input interface module for including a password restriction customized to meet a website requirement;
the program combines and processes the website data, the unique user identification data and the password restriction customized to meet a website requirement through the encryption algorithm to create a unique password;
a recall interface module executed by the computer to use input of the original website data and the unique user identification data to recreate the unique password from the computer; and
the password restriction customized to meet the website requirement allows a user to specify alphanumeric restrictions selected from a group comprising capitalization, character length, character type and combinations thereof.
